(19) United States
(12) Patent Application Publication
(10) Pub. No.: US 2007/0227581 A1
(43) Pub. Date: Oct. 4, 2007

(54) Concentrator solar cell module

(76) Inventors: Zupei Chen, Santa Clara, CA (US); Christina Ye Chen, San Diego, CA (US)

Correspondence Address: Michael Hetherington, Woodside Law Group, P.O. Box 61047, Palo Alto, CA, 94306, US

(21) Appl. No.: 11/390,045

(22) Filed: Mar. 28, 2006

(51) Int. Cl. H02N 6/00

(52) U.S. Cl. 136/246

(57) ABSTRACT

A solar cell array is directly affixed onto an optical concentrator having wide view-angle. The optical concentrator allows more light to concentrate onto the solar cell array, and as a result the size of the solar cell array is greatly reduced, which leads to a great reduction in material cost.

### FIELD OF THE INVENTION

The present invention is related to solar cell modules and, more particularly, to a concentrator solar cell module by integrating an optical concentrator and solar cell elements, which is capable of reducing the cost of solar cell modules.

### BACKGROUND OF THE INVENTION

A solar cell can convert solar energy in to electrical energy in a safe, convenient, pollution-free, and theoretically, inexpensive manner. There are many types of solar cells, including crystalline semiconductor solar cells, thin film solar cells, organic solar cells, thermal solar cell, etc.

Because the energy output from a single solar cell is very limited, typically a plurality of solar cell elements are connected together via interconnects to form a solar cell array in a solar cell module. A solar cell module can produce from tens to thousand watts of electrical power output and constitutes the basic unit of the solar cell system.

Crystalline silicon solar cell module is most common among all. FIG. 1 illustrates a conventional crystalline silicon solar cell module 10. The crystalline silicon solar cell module 10 includes a crystalline silicon solar cell array 15 formed a plurality of the individual solar cell elements connected by a interconnects 16, 17, and 18, the plurality of individual solar cell elements and interconnects are encapsulated in an encapsulation layer 12, wherein the encapsulation layer 12 is sandwiched between a transparent safety glass 11 and a substrate 13. The photocurrent of the crystalline silicon solar cell array 15 is output from two electrodes 14 and 19. The crystalline silicon solar cell module 10 usually has a flat-plane shape and has a wide view angle. However, the silicon wafer covers the total light receiving area. Therefore, this type of crystalline silicon solar cell module 10 requires a large amount of silicon wafer which increases manufacturing costs.

Many concentrator solar cell modules are developed and constructed by integrating a solar cell array and a plurality of plastic lenses together. The plastic lenses can be used as a concentrator to focus sun light onto low cost small solar cell elements, which can greatly decrease the overall manufacturing cost of solar cell modules. However, the view angle of the plastic lens is relatively small, therefore, in actuality a sun light tracker needs to be added to the concentrator solar cell module. This adds an additional maintenance fee to the overall cost of the module.

As will be seen more fully below, the present invention is substantially different in structure, methodology and approach from that of other solar cell modules and solar cell systems.

### SUMMARY OF THE INVENTION

The preferred embodiment of the concentrator solar cell module and array of the present invention solves the aforementioned problems in a straight forward and simple manner.

The present invention contemplates a concentrator solar cell module comprising a solar cell array and an optical concentrator. The solar cell array is attached to the optical concentrator has a wide view-angle.

An object of the present invention is to provide a concentrator solar cell module with a optical concentrator constructed and arranged as a reflection prism having a wedge shape.

Another object of the present invention is to provide a concentrator solar cell module with a optical concentrator that is a semi-cylindrically shaped lens. The lens has a curved transparent surface and flat surface.

A further object of the present invention is to provide a concentrator solar cell module that has a reflection surface without any mirror attachment and without any coating.

A still further object of the present invention is to provide a concentrator cell module with a reflection surface which is formed as a blazed grating with a blazed grating angle between 0° to 50°, has a mirror or a metal coating applied directly thereto.

A still further object of the present invention is to provide a concentrator solar cell module wherein the optical concentrator is constructed and arranged to provide a 180° view-angle with respect to a transparent surface of the optical concentrator.

The present invention also contemplates a solar cell module array comprising a plurality of solar cell module elements, each module element having a solar cell array and an optical concentrator. The solar cell array is attached to the optical concentrator.

A further object of the present invention is to provide an array wherein the optical concentrator is a reflection prism having a wedge shape and each optical concentrator of each solar cell module is identically shaped.

Another object of the present invention is to provide an array with a plurality of solar cell modules that are paired to form a plurality of paired module units. The solar cell modules of the paired module unit are interconnected to form a high voltage output. The paired module unit is arranged to form an angle between the transparent surfaces thereof wherein the angle is between 100° and 180°.

A still further object of the present invention is to provide an array wherein a view angle of the paired module unit can be achieved by selecting the angle between the large transparent surfaces.

A still further object of the present invention is to provide an array wherein the plurality of solar cell modules are arranged in tandem and oriented in a same direction.

The objective of this invention is to provide a concentrator solar cell module, which can be manufactured at low cost.

The above and other objects and features of the present invention will become apparent from the drawings, the description given herein, and the appended claims.

### BRIEF DESCRIPTION OF THE DRAWING

For a further understanding of the nature and objects of the present invention, reference should be had to the following description taken in conjunction with the accompanying drawings in which like parts are given like reference numerals and, wherein:

FIG. 1 illustrates a schematic cross-sectional view of the conventional flat-plane solar cell module;

FIG. 2 is an exploded schematic of a cross-sectional view of a representative portion of a concentrator solar cell module prepared according to a first embodiment of the present invention;

FIG. 3 illustrates a schematic of a cross sectional view of the representative portion of the concentrator solar cell module prepared according to the first embodiment of the present invention;

FIG. 4 illustrates a schematic of a cross sectional view of the representative portion of the concentrator solar cell module prepared according to second embodiment of the present invention;

FIG. 5 illustrates a plot for the incident angle distribution vs. photo current for a concentrator solar cell module for a prism angle β=26.60;

FIG. 6 is a plot of an angle distribution of photo current of a concentrator solar cell module array with a pair of concentrator solar cell modules;

FIG. 7 illustrates a cross sectional view of a concentrator solar cell module array in accordance with the present invention;

FIG. 8 illustrates a cross sectional view of an alternative embodiment of the concentrator solar cell module array; and,

FIG. 9 illustrates a schematic cross sectional view of a representative portion of a concentrator solar cell module prepared according to third embodiment of the present invention.

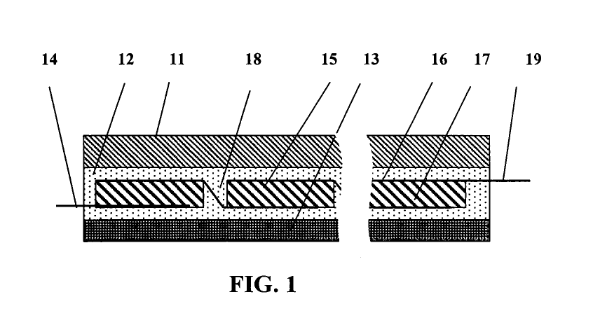

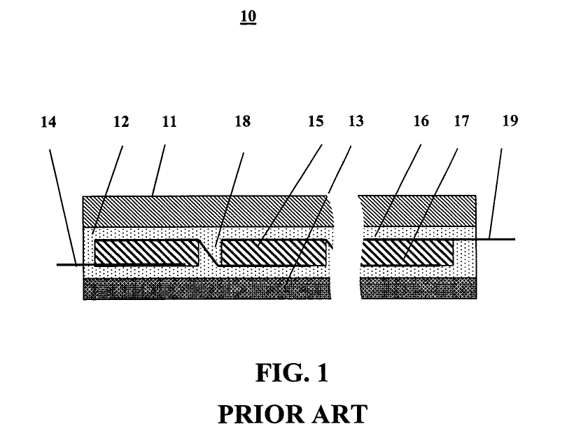

### DESCRIPTION OF THE EMBODIMENTS

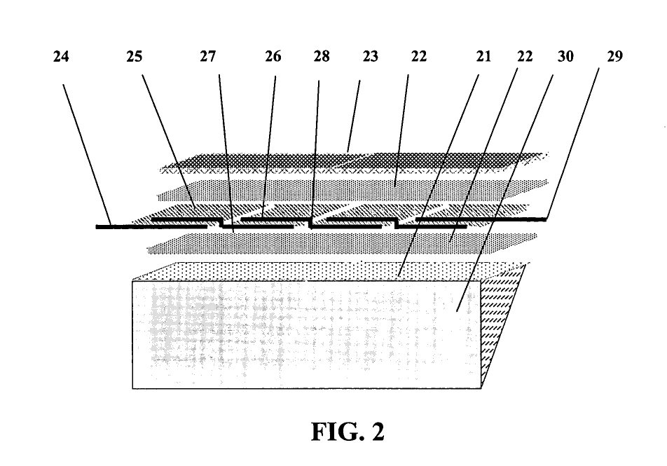

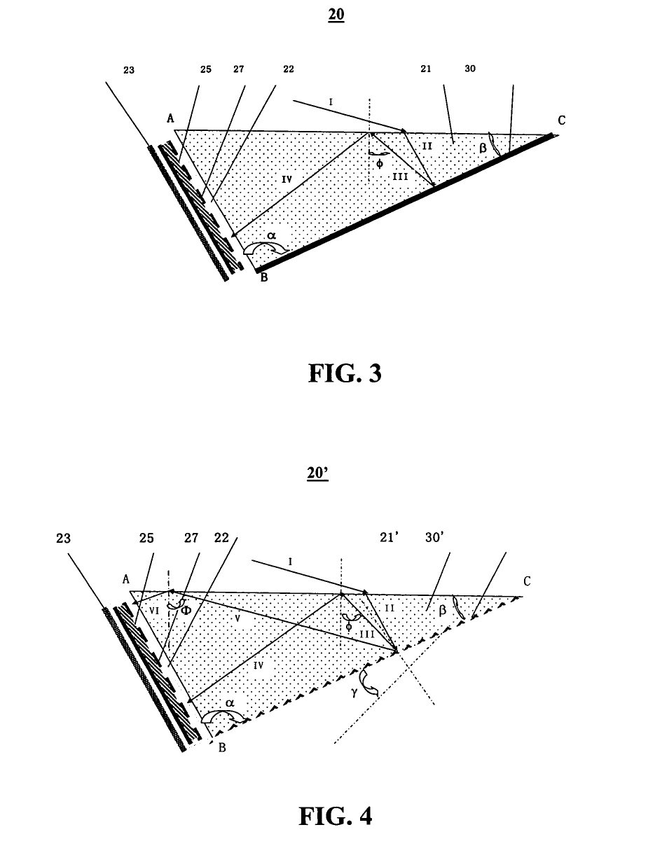

Referring now to the drawings and in particular FIGS. 2-3, the concentrator solar cell module 20 integrates a solar cell array 25 with a solar optical concentrator, such as, a reflection prism 21 by using an encapsulation layer 22. The solar cell array 25 comprises a plurality of individual solar cell elements connected by a plurality of interconnects 26, 27 and 28. In the first exemplary embodiment, the reflection prism 21 is a wedge-shaped prism having a mirror 30 attached thereto to form a reflection surface BC. The photocurrent of the crystalline silicon solar cell array 15 is output from two electrodes 24 and 29. The encapsulation layer 22 is bounded by substrate 23. In the exemplary embodiment, the substrate 23 is made weather-resistance solid state materials and has a thickness between 0.01 mm and 0.1 mm.

The mirror 30 can be a separate mirror component or a coating applied directly to the surface BC to form a mirror. Alternately, in lieu of a mirror, the reflection surface BC can be coated with a metal coating. In the preferred embodiment, the metal coating is aluminum. Furthermore, the reflection surface BC may be formed by coating the surface BC with a dielectric coating. As can be appreciated, the reflection prism 21 is constructed and arranged to serve as an optical concentrator. Furthermore, the internal side of the reflection surface BC provides a total inner reflection surface without any mirror attachment and without any coating.

The material of the reflection prism 21 can be made of solid state materials. Optical plastic materials are preferred. Alternately, the material of the reflection prism 21 can be a transparent liquid material such as, without limitation, Carbon Chloride CCL₄. The reflection prism 21 may be made of optical transparent liquid materials filled in a transparent prism-shaped box or shell contoured to form the wedge-shape or other shapes of the prism 21.

The solar cell array 25 can be any flat-plane solar cell array such as, without limitation, a crystalline silicone wafer-based solar cell array. The encapsulation layer 22 is made from one of: hot melt adhesive, ethylene vinyl acetate (EVA), etc. However, EVA is preferred. The interconnects 26, 27 and 28 are welded to each of the solar cell elements without using a flux. Alternately, the solar cell may be a thin film solar cell coated on a small surface AB of the reflection prism 21.

In general, the reflection prism 21 has a transparent surface AC, a small surface AB and a reflection surface BC wherein the solar cell array 25 is attached on the small surface AB. The incident light being incident on the transparent surface AC, travels toward the reflection surface BC where it is totally reflected to form reflected light that travels back toward to the transparent surface AC with a large angle.

In the exemplary embodiment, the length of the wedge-shaped reflection prism 21 is in the range of 0.1 m to 2 m and the prism angle θ is in the range of 0° to 50°. The width of the solar cell array 25 is in the range of 0.1 mm to 100 mm. The small surface AB and reflection surface BC cross at an angle α between 60° to 120°. The reflection surface BC and the front transparent surface AC cross at the prism angle β between 0° to 50°.

As best seen in FIG. 3, the incident light following path I is refracted at the front transparent surface AC, the refracted light follows path II where the refracted light is reflected at the reflection surface BC and forms reflected light. The reflected light following path III is totally reflected at the front transparent surface AC, and then follows the reflected light path IV which is passed through the small surface AB, and converted into electrical output at electrodes 24 or 29 by the solar cell array 25.

For same effective receiving area, the size of the solar cell elements in the solar cell module 20 is less than that of the solar cell elements in flat-plane solar cell module of the prior art as long as the area of the small surface AB is smaller than the area of the front transparent surface AC. The view angle is a variation range of the incident angle which is with reference to the normal of the transparent surface AC.

Referring again to FIG. 3, if the angle β (that is opposite to the small surface AB of the prism 21, also the smallest angle of the reflection prism 21) is not smaller than the total reflection angle Φ₀ as defined by equation Eq. (1)
β>/=Φ₀=arcsin(1/n) Eq. (1)
where n is the refraction index of the prism materials, the turn back light satisfies the criteria for total reflection condition at that light incident surface (the transparent surface AC), and the turn back light from the reflection surface BC is totally reflected, concentrated and toward the small surface AB and then the light travels through and converted to electrical power by the solar cell array 25.

According to this arrangement, the solar cell array 25 is attached on the small surface AB of the reflection prism 21; the size of the solar cell array 25 is significantly reduced and the reflection prism 21 functions as a solar concentrator. As a result, much less semiconductor material and much less manufacturing cost are required.

Compared to using a traditional solar cell array, the conservation ratio A of concentration of the concentrator solar cell module 20 of present invention is defined by equation Eq. (2),
A=1/sin βEq. (2)

While not wishing to be bound by theory, in the present invention, the conservation ratio A increases as the prism angle β decreases. The maximum of the conservation ratio A is dependent on the smallest angle of the reflection prism 21. According to equation Eq. (1), the smallest angle that can maintain 180° view angle is Φ₀=arcsin (1/n), hence A=n. For glass, n=1.5, Φ₀=41.84° and A=1.5.

The prism angle β can be smaller than the total reflection angle Φ₀, and the value of the conservation ratio A increases as the prism angle β decreases, hence, the concentrator prism's view angle also decreases.

FIG. 4 is a schematic cross sectional view of a representative portion of a second embodiment of the concentrator solar cell module 20′. In this case, the reflection surface BC of the concentrator solar cell module 20′ includes brazed grating 30′, and the brazed grating angle γ can be 0° to 50°. The brazed grating 30′ can be attached to the surface BC of the prism 21′ as a separate component or it can be formed by etching the reflection surface BC of the prism 21.

In operation, the incident light following path I refracts at the front transparent surface AC. The diffraction angle of the brazed grating is wavelength dependent, and the diffraction angle of incident light following path II as it hits the brazed grating 30′ of the reflection surface BC is larger for longer wavelength light following path V compared to that of a shorter wavelength light following path III. The diffraction light following path III and V then travels through and hits the front transparent surface AC with a larger incident angle, and it is totally reflected at that surface. The reflected light following path IV and VI passes through the small transparent surface AB where it is converted into an electrical output by the solar cell array 25.

The advantage of this design is that total reflection condition of the turn back light on front transparent surface AC can be reached easily and high conservation ratio A can be achieved when the prism angle β is smaller.

In the embodiment of FIG. 4, the incident light following path I is refracted on the transparent surface AC, and the refract light following path II being totally diffraction on the Blazed Grating 30′. The diffracted lights following path III and path V travel back toward the transparent surface AC with a large angle Φ and Ψ which is wavelength dependent and much more than the angle β of the reflection prism 2. Because of the totally internal reflection, the turn back light following path III and V are fully reflected, and the reflected lights following path IV and VI are toward the small surface AB, where it is converted to electrical energy by the flat-plane solar cell array 25 sandwiched with the wage prism 30′ and back protection plate 23. The light following path V has larger diffraction angle Φ. The light following path III has smaller diffraction angle φ.

According to this arrangement, the prism angle is much smaller and the conservation ratio A is higher.

With the techniques stated above, this invention presents a new and improved concentrator solar cell module 20, which integrates an optical concentrator and a solar cell array 25 together. The optical concentrator concentrates more sun light onto the smaller solar cell array, which greatly decrease the manufacturing cost of the solar cell arrays.

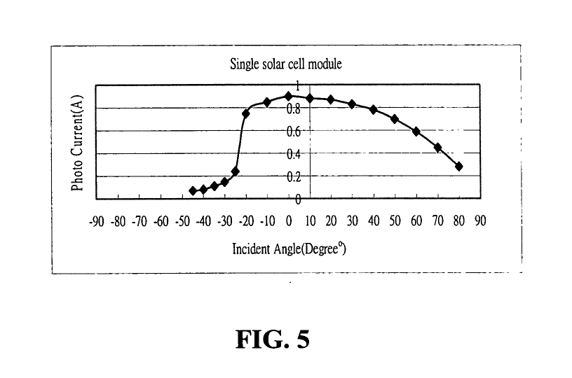

FIG. 5 is a plot for the incident angle distribution vs. photo current for a concentrator solar cell module at β=26.5°. The photo current is maximum at normal incident (0°), and it is represented by A, A=1/sin β. The photo current is very small between −90 to −20 degree incident angle, and this is because the incident light III at transparent surface AC cannot achieve total reflection. The prism angle β smaller, the conservation ratio A larger, the view angle smaller. The optimum conservation ratio A is designed based on the location and seasonal variation of the incident sunlight.

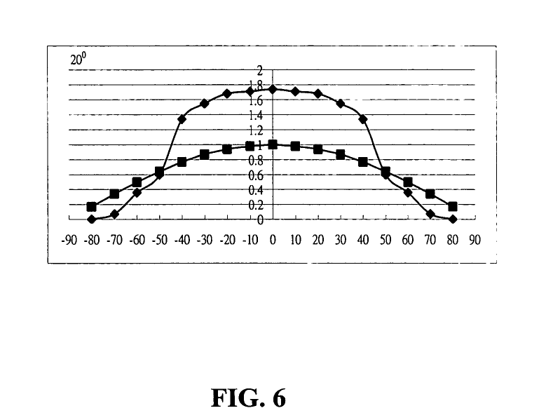

FIG. 6 is a plot of an angle distribution of photo current of a concentrator solar cell module array with a pair of concentrator solar cell modules.

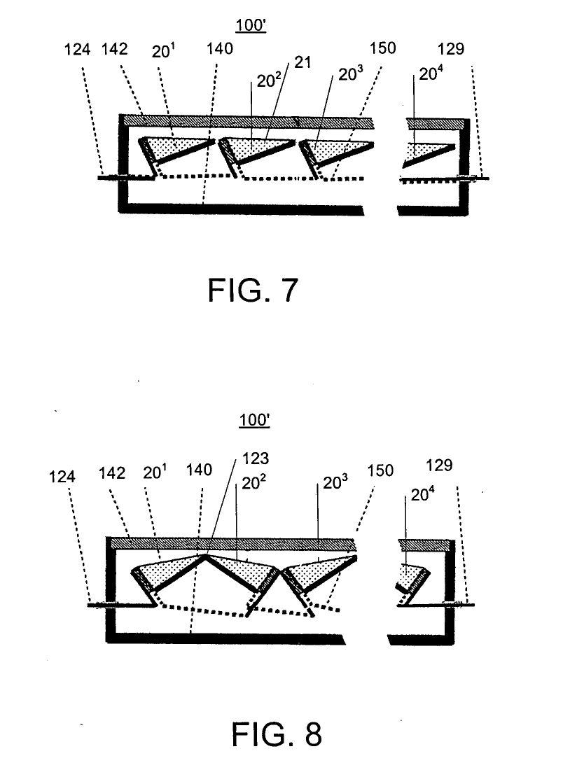

Referring now to FIG. 7, the solar cell module array 100 includes a plurality of concentrator solar cell modules 20¹, 20², 20³, . . . 20^{x} wherein each reflection prism 21 of each concentrator solar cell module 20¹, 20², 20³, . . . 20^{x} is essentially identical and arranged in tandem one after the other and connected by line 150 (shown in phantom). The array 100 outputs electrical energy from the first solar cell module 201 on line 124. Additionally, the array 100 outputs electrical energy from the last solar cell modules 20^{x} on line 129.

As best seen in FIG. 7, the array 100 arranges each adjacent reflection prism 21 in tandem one after the other such that the transparent surface AC of all prisms are aligned in the same plane. Furthermore, the tip (the apex of prism angle β) of one reflection prism 21 is immediately adjacent to the small surface AB of the immediately adjacent reflection prism 21 of the adjacent solar cell module.

Referring now to FIG. 8, the solar cell module array 100′ includes an array of a plurality of concentrator solar cell modules 20¹, 20², 20³, . . . 20^{x} wherein each reflection prism 21 of each concentrator solar cell module 20¹, 20², 20³, . . . 20^{x} is essentially identical. The array 100′ outputs electrical energy from the first solar cell module 20¹ on line 124. Additionally, the array 100′ outputs electrical energy from the last solar cell modules 20^{x} on line 129.

As best seen in FIG. 8, the array 100′ arranges two adjacent concentrator solar cell modules into a pair of concentrator solar cell modules. Since the pair of concentrator solar cell modules are essentially the same only one such pair of concentrator solar cell modules 20¹, 20² will be described in detail.

The pair of concentrator solar cell modules 20¹, 20² orients the tips (the apex of prism angle β) of the reflection prisms 21 such that cell module 20¹ and concentrator solar cell module 20² are symmetrically aligned. Thereby, the reflection surface BC of module 20¹ and the reflection surface BC of module 20² are angled with respect to the other. The angle φ may be up to 80°.

The angle of between the two larger transparent surfaces AC of paired adjacent modules, is between 100° and 180°. The optimization of the view angle can be achieved by selecting the angle between the large transparent surfaces AC of the paired modules. The paired modules are connected using interconnect 123 and to form a high voltage output.

In both FIGS. 7 and 8, the arrays 100 and 100′ include a housing structure 140 that encases the array of modules or array of paired modules. The housing structure 140 has a top or front protection glass 142.

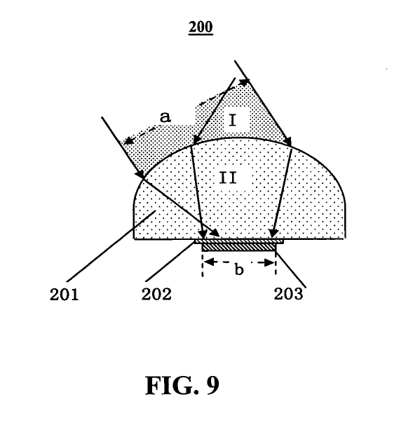

Referring now to FIG. 9, a third embodiment of a solar cell module 200 is shown. In the third embodiment, the solar cell array 203 is attached on an optical concentrator, a cylinder lens 201, the cylinder lens 201 has a curved surface and a flat-plane surface. The solar cell array 203 is attached on the flat-plane surface.

In operation, the light being incident on the curved surface, refracted, then travels toward the flat-plane surface and converted to electrical power by the solar cell array 203. The view angle is dependent on the width b of the solar cell array 203 and the focal length L^{f}. The conservation ratio A of the third embodiment is dependent on the view angle of the solar cell array 203. The smaller the view angle, the higher the conservation ratio A.

The solar cell module 200 integrates the solar cell array 203 with the cylinder lens 201 buy using a encapsulation layer 202. The solar cell array 203 comprises a plurality of solar cell elements connected by a plurality of interconnects. The length of the cylinder lens 201 is up to 2 m and the width of the solar cell array 203 is up to 20 mm and the radius is in the range of 5 mm to 100 mm.

The material of the cylinder lens 201 can be selected in all solid state materials wherein optical plastic materials are preferred. The cylinder lens 201 can be made of a transparent liquid material such as CCL₄. The solar cell array 203 can be any flat-plane solar cell array wherein the crystalline silicone wafer-based solar cell array is preferred.

In operation, the incident light following path I is refracted at the front curved surface, the refracted light following path II is converted into electrical output by the solar cell array 203. For same effective width of the receiving area and a cylinder lens of half cylinder or circle, the width b of the solar cells in the concentrator solar cell module is n times less than that width a of the solar cell element in flat-plane solar cell module where n is the refractive index. The conservation ratio a/b=n=A. For glass, n=1.5 and A=1.5. For the cylinder lens 201 of sup-half cylinder, width a is larger than the refractive index n, and the view angle is smaller.

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

What is claimed is:

1. A concentrator solar cell module comprising a solar cell array and an optical concentrator, said solar cell array is attached to said optical concentrator.

2. The concentrator solar cell module according to claim 1 wherein said optical concentrator is made of solid state materials.

3. The concentrator solar cell module according to claim 1 wherein said optical concentrator is made of optical transparent liquid materials filled in a transparent prism-shaped shell.

4. The concentrator solar cell module according to claim 1 wherein said optical concentrator is a reflection prism having a wedge shape.

5. The concentrator solar cell module according to claim 4 wherein said optical concentrator is a semi-cylindrically shaped lens, said lens has a curved transparent surface and flat surface.

6. The concentrator solar cell module according to claim 5 wherein said flat surface of said semi-cylindrically lens is attached to said solar cell array; an encapsulation layer is provided between said solar cell array and said flat surface, and between said solar cell array and a substrate.

7. The concentrator solar cell module according to claim 5 wherein said semi-cylindrically lens has a thickness no smaller than its radius.

8. The concentrator solar cell module according to claim 6 wherein said reflection prism has a small surface, a transparent surface and a reflection surface, said small surface and said reflection surface are crossing at a first angle between 60° to 120° and said transparent surface and said reflection surface cross at a second angle between 0° to 50°.

9. The module according to claim 7 wherein said reflection surface has no mirror attachment and is without any metal coating, the reflection is formed by its total inner reflection.

10. The concentrator solar cell module according to claim 7 wherein said reflection surface is a metal coated surface of said prism.

11. The concentrator solar cell module according to claim 7 wherein said reflection surface is formed by attaching a mirror.

12. The concentrator cell module according to claim 7 wherein said reflection surface is formed as a blazed grating with a blazed grating angle between 0° to 50°.

13. The concentrator solar cell module according to claim 7 wherein said solar cell array comprises a plurality of interconnected solar cells, a substrate and encapsulation layer.

14. The concentrator solar cell module according to claim 12 wherein said plurality of interconnected solar cells is attached on said small surface of said reflection prism, the encapsulation layer is provided between said interconnected solar cell array and said reflection prism, and between said interconnected solar cell array and said substrate.

15. The concentrator cell module according to claim 12 wherein said substrate is made weather-resistance solid state materials and has a thickness between 0.01 mm and 0.1 mm.

16. The concentrator solar cell module according to claim 12 wherein said encapsulation layer is made of one of hot melt adhesives and ethylene vinyl acetate.

17. The concentrator solar cell module according to claim 12 wherein interconnects connecting said plurality of interconnected solar cells are welded to said solar cells.

18. The concentrator solar cell module according to claim 1 wherein said solar cell is a thin film solar cell coated on said small surface of said reflection prism.

19. The concentrator solar cell module according to claim 1 wherein said optical concentrator is constructed and arranged to provide a 180° view angle with respect to a transparent surface of the optical concentrator.

20. The concentrator solar cell module according to claim 1 wherein said concentrator is constructed and arranged to refract incident light through a transparent surface to a reflection surface, the reflection surface reflecting back the refracted light to the transparent surface to direct the reflected back light to the solar cell array where the reflected-back light is converted to electrical energy.

21. A solar cell module array comprising a plurality of solar cell modules, each module having a solar cell array and an optical concentrator, said solar cell array is attached to said optical concentrator wherein said optical concentrator has no mirror attachment and is without any mirror coating, reflection is formed by an inner total reflection of said optical concentrator.

22. The array according to claim 21 wherein said optical concentrator is made of solid state materials.

23. The array according to claim 21 wherein said optical concentrator is made of optical transparent liquid materials filled in a transparent prism-shaped shell.

24. The array according to claim 21 wherein said optical concentrator is a reflection prism having a wedge shape and each optical concentrator of each solar cell module is identically shaped.

25. The array according to claim 24 wherein said reflection prism has a small surface, a transparent surface and a reflection surface, said small surface and said reflection surface are crossing at a first angle between 60° to 120° and said transparent surface and said reflection surface cross at a second angle between 0° to 50°.

26. The array according to claim 25 wherein said plurality of solar cell modules are paired to form a plurality of paired module units, the solar cell modules of the paired module unit are interconnect to form a high voltage output and wherein each paired module unit is arranged to form an angle between the transparent surface and said small surface thereof wherein the angle is between 100° and 180°.

27. The array according to claim 26 wherein a view angle of the paired module unit can be achieved by selecting the angle between the transparent surfaces.

28. The array according to claim 25 wherein said reflection surface has no mirror attachment and is without any coating, reflection is formed by its total inner reflection.

29. The array according to claim 25 wherein said reflection surface is coated by a metal.

30. The array according to claim 25 wherein said reflection surface is formed by attaching a mirror.

31. The array according to claim 25 wherein said reflection surface is formed as a blazed grating with a blazed grating angle between 0° to 50°.

32. The array according to claim 25 wherein said solar cell array comprises a plurality of a plurality of interconnected solar cells, a substrate and encapsulation layer.

33. The array according to claim 25 wherein said plurality of interconnected solar cells is attached on said small surface of said reflection prism, the encapsulation layer is provided between said interconnected solar cell array and said reflection prism, and between said interconnected solar cell array and said substrate.

34. The array according to claim 25 wherein said plurality of solar cell modules are arranged in tandem and oriented in a same direction.

35. A concentrator solar cell module comprising means for converting solar light into electrical energy; and means, attached to said converting means, for optically concentrating and directing said solar light to said converting means wherein said optically concentrating means includes means for internally reflecting said solar light to said converting means.

36. The concentrator solar cell module according to claim 35 wherein said concentrating means is made of solid state materials.

37. The concentrator solar cell module according to claim 35 wherein said concentrating means is made of optical transparent liquid materials filled in a transparent prism-shaped shell.

38. The concentrator solar cell module according to claim 35 wherein said concentrating means is a reflection prism having a wedge shape.

39. The concentrator solar cell module according to claim 38 wherein said concentrating means is a semi-cylindrically shaped lens, said lens has a curved transparent surface and flat surface.

40. The concentrator solar cell module according to claim 39 wherein said converting means is attached on said flat surface of said lens; an encapsulation layer is provided between said converting means and said flat surface, and between said converting means and a substrate.

41. The concentrator solar cell module according to claim 38 wherein said reflection prism has a small surface, a transparent surface and a reflection surface, said small surface and said reflection surface are crossing at a first angle between 60° to 120° and said transparent surface and said reflection surface cross at a second angle between 0° to 50°.

42. The concentrator solar cell module according to claim 41 wherein said reflection surface has no mirror attachment and is without any coating, reflection is formed by its total inner reflection.

43. The concentrator solar cell module according to claim 41 wherein said reflection surface includes means for reflecting solar light.

44. The concentrator solar cell module according to claim 43 wherein said reflecting solar light means includes a mirror.

45. The concentrator solar cell module according to claim 44 wherein said reflecting solar light means includes a metal coating.

46. The concentrator cell module according to claim 41 wherein said reflection surface is formed as a blazed grating with a blazed grating angle between 0° to 50°.

47. The concentrator solar cell module according to claim 41 wherein said converting means includes plurality of interconnected solar cells attached on said small surface of said reflection prism, and
further comprising:
a substrate; and
an encapsulation layer provided between said interconnected solar cell cells and said reflection prism, and between said interconnected solar cells and said substrate.

48. The concentrator solar cell module according to claim 35 wherein said concentrating means is constructed and arranged to provide a 180° view angle with respect to a transparent surface of the concentrating means.

49. The concentrator solar cell module according to claim 35 wherein said concentrating means is constructed and arranged to refract incident light through a transparent surface to a reflection surface, the reflection surface reflecting back the refracted light to the transparent surface to direct the reflected back light to the converting means where the reflected-back light is converted to electrical energy.
